(19) United States
(12) Patent Application Publication
(10) Pub. No.: US 2014/0280915 A1
(43) Pub. Date: Sep. 18, 2014

(54) SYSTEMS, METHODS AND APPARATUS FOR MONITORING ONLINE ACTIVITY AND STORING AND DISPLAYING INFORMATION CONCERNING THE ONLINE ACTIVITY

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC.

(21) Appl. No.: 14/209,016

(22) Filed: Mar. 13, 2014

Related U.S. Application Data
(60) Provisional application No. 61/792,750, filed on Mar. 15, 2013.

(51) Int. Cl. H04L 12/26; H04L 12/58

(52) U.S. Cl. CPC H04L 43/08; H04L 51/32
USPC 709/224

(57) ABSTRACT

Online activity conducted via a user device is monitored. Usage information is recorded based on access by the user device to a first website via a network. Interaction information relating to an interaction that occurs via a social networking website different from the first website is recorded, based on access by the user device to the social networking website via the network. A summary of the online activity is generated based on the usage information and the interaction information. The summary is displayed on a display of the user device.

This application claims priority from U.S. Provisional Application No. 61/792,750, filed Mar. 15, 2013, which is hereby incorporated by reference herein in its entirety.

### TECHNICAL FIELD

This specification relates generally to systems and methods for managing online content and activities, and more particularly to systems and methods for monitoring online activity and storing and displaying information concerning the online activity.

### BACKGROUND

A large and continually increasing supply of content of all types is available via the Internet. Many users have a need to filter the available content, and/or monitor access to the available content, for a variety of purposes. For example, some users wish to prevent children from accessing certain types of content. Other users have a need to filter content efficiently in order to identify content of a desired nature. Some users wish to take the behavior of other users into account in filtering content. Accordingly, there is an ongoing need for improved systems and methods capable of filtering online content in a manner that achieves the objectives of each individual user. There is also a need for systems and methods to enable a first user (e.g., a parent) to monitor the online activities of a second user (e.g., a child).

### SUMMARY

In accordance with an embodiment, a method of providing information is provided. Online activity conducted via a user device is monitored. Usage information is recorded based on access by the user device to a first website via a network. Interaction information relating to an interaction that occurs via a social networking website different from the first website is recorded, based on access by the user device to the social networking website via the network. A summary of the online activity is generated based on the usage information and the interaction information. The summary is displayed on a display of the user device.

In one embodiment, the usage information indicates an amount of time spent by a user accessing the first website. In another embodiment, the interaction comprises one of receipt of a message, transmission of a message, and acquisition of a new friend.

In another embodiment, information relating to one or more messages sent or received by the user via the social networking website is accessed via a personalized social networking page associated with a user. In another embodiment, information relating to one or more friends acquired by the user via the social networking website is accessed via a personalized social networking page associated with a user.

In another embodiment, access information for accessing the social networking website is obtained by the user device while a user accesses the social networking website. The social networking website is subsequently accessed automatically, by the user device, based on the access information. The access information may comprise one of a username and a password.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows components of a user worldview service in accordance with an embodiment;

FIG. 4 shows components of a ratings service in accordance with an embodiment;

FIG. 5 shows components of a content manager in accordance with an embodiment;

FIG. 6 shows an exemplary social networking page created and maintained by a user via a third party social network service;

FIG. 7 shows an exemplary user login page in accordance with an embodiment;

FIG. 8 shows an exemplary menu page in accordance with an embodiment;

FIG. 9A shows a web page in accordance with an embodiment;

FIG. 9B shows a query box displayed over a web page in accordance with an embodiment;

FIG. 9C shows a ratings box displayed over a web page in accordance with an embodiment;

FIG. 9D shows a worldview factors box displayed over a web page in accordance with an embodiment;

FIG. 9E shows a second ratings box displayed over a web page in accordance with an embodiment;

FIG. 10 shows a web page in accordance with an embodiment;

FIG. 11 shows a combined content ratings database in accordance with an embodiment;

FIG. 12 shows a user trust score database in accordance with an embodiment;

FIG. 13 shows a combined content ratings database in accordance with another embodiment;

FIG. 14 shows a filtering criteria page in accordance with an embodiment;

FIG. 15 shows a user worldview database in accordance with an embodiment;

FIG. 16 is a flowchart of a method of filtering content in accordance with an embodiment;

FIG. 17 shows a message displayed above a web page in accordance with an embodiment;

FIG. 18A is a flowchart of a method of monitoring online activity and displaying information related to the online activity in accordance with an embodiment:

FIG. 18B shows a parental control page in accordance with an embodiment;

FIG. 19 shows an online activity page in accordance with an embodiment;

FIG. 20 shows a learn activities page in accordance with an embodiment;

FIG. 21 shows an inspire activities page in accordance with an embodiment;

FIG. 22 shows a fun activities page in accordance with an embodiment;

FIG. 23 shows an ethics activities page in accordance with an embodiment;

FIG. 24 shows a messages page in accordance with an embodiment;

FIG. 25 shows a chat messages page in accordance with an embodiment;

FIG. 26 shows a new friends page in accordance with an embodiment;

FIG. 27 shows a videos page in accordance with an embodiment;

FIG. 28A shows a games page in accordance with an embodiment;

FIG. 28B shows a statistics page in accordance with an embodiment;

FIG. 28C shows a points page in accordance with an embodiment;

FIG. 28D shows a web page in accordance with an embodiment;

FIG. 28E shows a system for applying parental settings to a child profile in accordance with an embodiment;

FIG. 28F shows a system for reporting unacceptable content in accordance with an embodiment;

FIG. 28G shows a system for filtering friend requests in accordance with an embodiment;

FIG. 28H shows a system for applying various settings to child profiles in accordance with an embodiment;

FIG. 28I shows a system for tracking a location of a child in accordance with an embodiment;

FIG. 28J shows a system for managing a wish list in accordance with an embodiment; and

FIG. 29 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, a user worldview service 120, a ratings service 130, and a content manager 140. Communication system 100 also includes a plurality of content servers 170-A, 170-B, 170-C, etc. Communication system 100 also comprises a plurality of user devices 160-A, 160-B, 160-C, etc. Communication service 100 also includes a third party social network service 155 and a third party email server 158.

For convenience, the term “content server 170” is sometimes used herein to refer to any one of content servers 170-A, 170-B, 170-C, etc. Accordingly, any discussion herein referring to “content server 170” is equally applicable to each of content servers 170-A, 170-B, 170-C, etc. Communication system 100 may include more or fewer than three content servers.

Similarly, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

Content server 170 stores content that may be accessed via network 105. For example, content stored on a content server may be provided to a user in the form of a web page, or in another format.

User device 160 may be any device that enables a user to communicate via network 105. User device 160 may be connected to network 105 through a direct (wired) link, or wirelessly. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, a user registration database 265 containing usernames, passwords, and other information relating to various users is stored in storage 230. Network manager 135 may include other components not shown in FIG. 2.

Network manager 135 collects and stores information about the activities and behavior of various users of communication network 105. For example, information indicating which websites a user visits, how often and when the user visits a web site, which products the user purchases, with whom a user communicates by email, etc., is recorded and stored. Such information is stored in a user behavior database 272 in storage 230, as shown in FIG. 2.

FIG. 3 shows components of user worldview service 120 in accordance with an embodiment. User worldview service 120 comprises a user polling module 310 and a storage 330. User polling module 310 may from time to time receive from a user information relating to the user's preferences, personal values, philosophy, beliefs, priorities, opinions, etc. Such information received from users is stored in a user worldview database 360 within storage 330. User worldview service 120 may include other components not shown in FIG. 3.

FIG. 4 shows components of ratings service 130 in accordance with an embodiment. Ratings service 130 comprises a ratings module 410 and a storage 420. Ratings module 410 from time to time receives from a user one or more ratings of selected content accessible via network 105, e.g., content accessible at an Internet address or at another network location. A user may submit a plurality of ratings, each rating relating to a respective attribute of the content. Ratings received from users are stored in a user ratings database 448 stored within storage 420. In the illustrative embodiment, ratings from multiple users are combined to generate combined ratings for various items of content. For example, averages or weighted averages of ratings from various users may be generated. In other embodiments, ratings from various users may be combined in other ways to generate combined ratings. The combined ratings are stored in a combined content ratings database 450 within storage 420. Ratings service 130 may include other components not shown in FIG. 3.

FIG. 5 shows components of content manager 140 in accordance with an embodiment. Content manager 140 comprises a content server 510, a filtering module 520, and a storage 530. Content server 510 from time to time provides content to a user. For example, content server 510 may receive from a user employing a user device 160 a request for content associated with a particular web page which is associated with a particular world wide web address. In response, content manager 140 identifies a content server 170 that stores the requested content, retrieves the content from the content server, and provides the content (e.g., in the form of a web page) to user device 160. Filtering module 520 filters content based on a variety of parameters. Thus, from time to time filtering module 520 may prevent content server 510 from providing a particular item of content to a particular user or user device, based on one or more filtering parameters. Storage 530 is used by other components of content manager 140 to store various types of data. Content manager 140 may include other components not shown in FIG. 5.

Third party social network service 155 allows users to maintain respective personalized social networking pages and to interact with other users using various social networking tools. For example, a user may send and receive various types of messages from other users. A user may connect with another user as a “friend.” Information relating to a user's interactions in the social network, including lists of friends, lists of messages, etc., may be displayed on the user's personalized social networking page. In a known manner, a user may be required to enter a username and password to access the social network and his or her personalized social networking page. In one embodiment, network manager 135 is operated by a first entity and third party social network service 155 is operated by a second entity different and independent from the first entity.

FIG. 6 shows an exemplary social networking page created and maintained by a user via third party social network service 155. Page 600 includes an image 619 of the user and the name (622) of the user. Page 600 also includes a list 610 of the user's friends within the social network. In the illustrative example of FIG. 6, the user's friends include Evan 612, Josephine 614 and Rob 616. Page 600 also includes a Messages tab 641 that enables the user to view his or her messages. An unread messages tab 643 indicates that the user currently has two (2) unread messages. Page 600 also includes a CHAT tab 652 that enables the user to initiate a chat session with another user, and an Email tab 654 that enables the user to access his or her email inbox, send email messages, etc.

Third party email server 158 provides an email service in a known manner. Thus, third party email server 158 may allow a user to create an email account, which may be used to send and receive email messages, to maintain an email message inbox in which messages are stored, etc. Third party email server 158 may require a user to provide a username and password prior to accessing the user's email account. In one embodiment, network manager 135 is operated by a first entity and third party email server 158 is operated by a second entity different and independent from the first entity.

In accordance with an embodiment, a user may access content via network 105 and provide one or more ratings of the content. In an illustrative embodiment, suppose that a user employing user device 160-A accesses a website maintained by network manager 135. For example, the user may utilize a browser application (not shown) residing and operating on user device 160-A to access the website. Upon accessing the website, user registration & login module 220 (of network manager 135) may provide a user login page such as that shown in FIG. 7. User login page 700 includes a username field 710 and a password field 720. After the user enters a valid username and password, and is authenticated, controller 210 (of network manager 135) causes the browser on user device 160-A to display a menu page such as that shown in FIG. 8 that indicates one or more products and/or services available via the website. Menu page 800 presents a plurality of selections including a search button 810, a games button 820, a chat button 830, a store button 840, a music button 850, and an email button 860. Other selections may be included.

Supposing that the user wishes to view content available via network 105, the user specifies, in an address bar 807 of the browser, a network address, ADDRESS1 (809), associated with the desired content, as shown in FIG. 8. The browser (of user device 160-A) provides the address to network manager 135. Network manager 135 forwards the address to content manager 140. In response, content server 510 (of content manager 140) retrieves the specified content from the appropriate content server 170. Content manager 140 then causes user device 160-A to display the content (in the form of a web page). In the illustrative embodiment, the user accesses a web page associated with a history website, as shown in FIG. 9A. Web page 900 comprises a plurality of articles related to various historical topics, including a first article 902 related to “George Washington Biography,” a second article 904 related to “Ancient Chinese Terra-Cotta Soldiers Discovered,” and a third article 906 related to “Trade in Pre-Columbian America.”

While the user is accessing web page 900, ratings module 410 (of ratings service 130) causes user device 160-A to display a “Rate Content” option 911 at a selected location on web page 900. In the illustrative embodiment, Rate Content button 911 is displayed within address bar 807, in the upper-right corner of web page 900.

While the user is visiting web page 800, the user selects Rate Content option 911. In response, ratings module 410 (of ratings service 130) causes user device 160-A to display a query box 933 on web page 900, as shown in FIG. 913. Query box 933 asks the user if he or she wishes to rate the content of web page 900. The user may select “YES” button 941 if the user wishes to rate the content or “NO” button 942 if the user does not wish to rate the content.

In the illustrative embodiment, the user selects “YES” button 941. In response, ratings module 410 (of ratings service 130) causes user device 160-A to display a ratings box 955 on web page 900, as shown in FIG. 9C. Ratings box 955 includes a learn field 966, an inspire field 967, a fun field 968, and an ethics field 969, allowing the user rate the content of web page 900 with respect to each of these respective attributes or parameters. In the illustrative embodiment, the user of user device 160-A deems the web page to be useful for learning and assigns a rating of “8” for the learn attribute (field 966). The user believes that the web page is moderately inspirational and thus assigns a “6” for the inspire attribute (field 967). The user believes that the web page is not very fun and thus assigns a “3” to the fun attribute (field 968). The user feels that the web page encourages ethical thinking and thus assigns a “6” to the ethics attribute (field 969). When the user wishes, he or she may then submit his or her ratings by selecting a “SUBMIT” button 970 within box 955.

Ratings module 410 may request additional ratings relating to other topics. Referring to FIG. 9D, for example, ratings module 410 causes user device 160-A to display a worldview factors box 975 which invites the user to rate the content of web page 900 with respect to the content's relationship to one or more topics, issues, etc. In the illustrative embodiment, box 975 includes a religion question 984 asking whether the content in question is oriented to any particular religion, and a politics question 986 asking whether the content is oriented to any particular political viewpoint.

Referring to FIG. 9E, ratings module 410 causes user device 160-A to display a second ratings box 979 asking the user to enter, in a field 981, an age requirement for the content, and, in field 983, to indicate whether or not the content contains violence.

While in the illustrative embodiment described herein, ratings are obtained with respect to certain attributes and questions, these examples are not to be construed as limiting. In other embodiments, ratings and answers may be obtained from a user concerning any content attribute and with respect to any type of question, on any topic.

After the user provides ratings and/or answers with respect to various attributes, parameters and/or questions, ratings module 410 receives the user's ratings and answers and stores the ratings and answers in a user ratings database 448, which is maintained in storage 420 (shown in FIG. 4). User rating database 448 thus records the ratings information submitted by various users of communication system 100 as the users view and rate various items of content.

Suppose that the user of user device 160-A now visits a videogame website associated with a second address ADDRESS2. As shown in FIG. 10, when the user accesses the videogame website, content manager 140 retrieves the content associated with ADDRESS2 (808), which is displayed in address bar 807, and causes user device 160-A to display a web page such as that shown in FIG. 10. Web page 1000 is associated with a violent videogame called “Blood & Guts Videogame.” In a manner similar to that described above, while the user is visiting web page 1000, ratings service 130 causes Rate Content button 911 to appear in address bar 807. Supposing that the user selects Rate Content button 911, ratings service 130 causes user device 160-A to display ratings box 955 on the web page, as shown in FIG. 10. Now the user indicates enters a “0” for the learn parameter (field 966), a “0” for the inspire parameter (field 967), a “5” for the fun parameter (field 968), and a “0” for the ethics parameter (field 969), and submits the ratings by pressing “SUBMIT” button 970. Ratings module 410 receives the user's ratings and stores the ratings information in user ratings database 448.

Ratings module 410 accesses the ratings received from users, as recorded in user ratings database 448, and generates, for one or more items of content available via network 105, a combined rating representing a combination of the various ratings received. For example, ratings module 410 may average user ratings received for a particular item of content, where appropriate, to generate a set of averaged user ratings for the content. Other methods may be used to combine user ratings. Combined ratings are stored in combined content ratings database 450 (as shown in FIG. 4).

FIG. 11 shows combined content ratings database 450 in accordance with an embodiment. Database 450 comprises a content identifier column 1111 holding an identifier of particular content available via network 105. For example, content identifier column 1111 may hold a world wide web address associated with a web page, or another type of address. Database 450 also includes a learn column 1113 indicating a learn rating associated with the content identified in column 1111. For example, learn column 1113 may hold a running average of learn ratings received from users with respect to the content. Database 450 includes an inspire column 1115 indicating an inspire rating associated with the content identified in column 1111. For example, inspire column 1115 may hold a running average of inspire ratings received from users with respect to the content. Database 450 includes a fun column 1117 indicating a fun rating associated with the content identified in column 1111. For example, fun column 1117 may hold a running average of fun ratings received from users with respect to the content. Database 450 includes an ethics column 1119 indicating an ethics rating associated with the content identified in column 1111. For example, ethics column 1119 may hold a running average of ethics ratings received from users with respect to the content. Database 450 also includes a religion column 1121 indicating a degree to which the content is associated with any particular religion. Column 1121 may hold one or more percentage values indicating what percentage of respondents indicated that the content is oriented to a particular religion. Database 450 also includes a politics column 1123 indicating a percentage of respondents who indicated that the content is associated with a particular political viewpoint. Database 450 also includes an age column 1125 reflecting an average of user ratings relating to age appropriateness, and a violence column 1127 reflecting a percentage of respondents who indicated that the content contains violence.

Database 450 may include other columns containing ratings related to any other type of issue that may be of interest to some or all users. For example, in the illustrative embodiment of FIG. 11, database 450 includes an evolution column 1129 indicating a percentage of respondents who indicated that the content is oriented toward evolution.

Thus, referring to record 1146, the content available at the history website address has obtained an average 7.8 rating for the learn parameter, an average 6.6 rating for the inspire parameter, an average 2.4 rating for the fun parameter, and an average 7.1 rating for the ethics parameter. Zero percent (0%) of respondents indicated that the content is oriented to any religion. Eighteen percent (18%) of respondents indicated that the content is oriented to a politically liberal viewpoint. Users indicated that the content is appropriate for all ages. Zero percent (0%) of respondents indicated that the content contains violence. Zero percent (0%) of respondents indicated that the content is related to evolution.

Referring now to record 1147, the content available at the Blood & Guts Videogame website address has obtained an average 1.3 rating for the learn parameter, an average 2.5 rating for the inspire parameter, an average 7.5 rating for the fun parameter, and an average 0.3 rating for the ethics parameter. Zero percent (0%) of respondents indicated that the content is oriented to any religion. Zero percent (0%) of respondents indicated that the content is oriented to a political viewpoint. Users indicated that the content is appropriate for persons older than 17 years of age. Ninety-seven percent (97%) of respondents indicated that the content contains violence. Zero percent (0%) of respondents indicated that the content is related to evolution.

In accordance with another embodiment, each user of communication system 100 has an associated trust score indicating a level of trust that the user has earned from other users (and/or from network administrators). For example, a trust score may be a value from zero to ten. In the illustrative embodiment, a newly-registered user has a trust score of zero; the user's trust score may increase based on a variety of factors including the user's role and actions within communication system 100, the user's demonstrated knowledge of certain topics, etc. For example, in one embodiment, a user's trust score may increase after being registered for a predetermined period of time. In another embodiment, a user may increase his or her trust score by rating content; for example, the user's trust score increases by a predetermined amount for every ten ratings the user generates. In another embodiment, a user's role in the community may influence his or her trust score. For example, a user who is a religious leader may earn a higher trust score.

In the illustrative embodiment of FIG. 2, controller 210 (of network manager 135) stores user trust scores in user trust score database 279. FIG. 12 shows user trust score database 279 in accordance with an embodiment. User trust score database 279 comprises a column 1202 holding identifiers of various users and a column 1204 holding a trust score for each respective user. Thus, record 1221 indicates that the user identified as User-1 has a trust score of 7.3; record 1222 indicates that the user identified as User-2 has a trust score of 0.8; and record 1223 indicates that the user identified as User-3 has a trust score of 3.5. As a user's trust score increases or decreases, user trust score database 279 is updated to reflect the change.

In accordance with another embodiment, ratings module 410 (of ratings service 130) may determine a combined rating for a particular item of content based on user ratings and on user trust scores. For example, ratings module 410 may determine a weighted average rating for a particular attribute of the item of content. Thus, for example, in order to determine a combined learn rating for a particular item of content, ratings module 410 may examine the learn ratings submitted by users for the content, and, for each respective user, weight the user's learn rating based on the user's trust score to generate a weighted learn rating. Ratings module 410 may then calculate a weighted average learn rating for the content based on all the weighted learn ratings computed in this manner. In other embodiments, the combined ratings in combined content ratings database 450 may be determined in a different manner.

FIG. 13 shows combined content ratings database 450 in accordance with an embodiment, in which combined rating values are determined based on weighted average values. Database 450 comprises a content identifier column 1311 holding an identifier of particular content available via network 105. Database 450 also includes a weighted average learn rating column 1313, a weighted average inspire rating column 1315, a weighted average fun rating column 1317, a weighted average ethics rating column 1319, a weighted percentage religion rating column 1321, a weighted percentage politics rating column 1323, a weighted average age rating column 1325, a weighted percentage violence rating column 1327, and a weighted percentage evolution rating column 1329. Thus, for example, record 1346 indicates that the content identified as history website has a weighted average learn rating of 8.4, a weighted average inspire rating of 6.8, a weighted average fun rating of 2.7, a weighted average ethics rating of 6.7, a weighted percentage religion rating of two percent (2%), a weighted percentage politics rating of 14% Liberal, a weighted average age rating of ALL, a weighted percentage violence rating of zero percent (0%), and a weighted percentage evolution rating of zero percent (0%).

In accordance with an embodiment, information relating to a user's personal values, philosophy, preferences, beliefs, priorities, opinions, etc., is obtained, stored, and utilized subsequently to filter content for the user.

Referring again to the illustrative embodiment of FIG. 1, suppose now that a new user employing user device 160-B registers and logs into the website maintained by network manager 135, for example, by entering a username and password on user login page 700 (shown in FIG. 7). After logging in, user worldview service 120 detects that the user is a new user and prompts the user to enter information concerning the user's personal values, philosophy, preferences, beliefs, priorities, opinions, etc. For example, user polling module 310 (of worldview service 120) may cause user device 160-B to display a filtering criteria page such as that shown in FIG. 14. Page 1400 comprises a plurality of parameter fields allowing the user to enter information defining his or her values, beliefs, priorities, etc.

Suppose that the user of user device 160-B has several children and wishes to establish filtering criteria for content accessed from user device 160-B, to ensure that the children do not access any content that does not conform to the user's priorities, values, etc. Referring to FIG. 14, fields 1411, 1413, 1415, and 1417 specify four filtering parameters LEARN, INSPIRE, FUN, and ETHICS, and allow the user to assign, for each respective parameter, a criterion that any content must satisfy in order to be accessed from user device 160-B. Thus, the user of user device 160-B, desiring content that facilitates learning, and content that inspires, assigns a minimum value of “7” for LEARN and minimum value of “6” for INSPIRE.

Thus content must have a minimum LEARN rating of “7” and a minimum INSPIRE rating of “6” to be accessed by user device 160-B. Not wishing to block academic content that may have a low FUN rating, the user assigns a relatively low minimum value of “2” to FUN. Thus, any content having a FUN rating of 2 or more may be accessed by user device 160-B. Concerned about the children viewing content that may encourage unethical behavior, the user assigns a minimum value of “6” to ETHICS.

Page 1400 also includes an age field 1421 and a violence field 1423. The user, wishing to block any content that is not specifically designed for children, and also wishing to block all violent content, enters “<16” in field 1421 and “NO” in field 1423.

Page 1400 also provides the user an opportunity to describe his or her affinities, views, opinions, etc. with respect to one or more topics. Page 1400 may prompt the user to enter answers to any type of question on any topic. In the illustrative embodiment, page 1400 presents a religion question 1435, where the user may indicate a religion, and a politics question 1445, where the user may indicate a political viewpoint. Other questions not shown in FIG. 14, related to other topics not shown in FIG. 14, may be presented.

User worldview service 120 receives the values submitted by the user to various parameters presented on web page 1400, and the user's answers to various question presented on web page 1400, and records the user information in a user worldview database 360, which is stored in storage 330, as shown in FIG. 3. FIG. 15 shows user worldview database 360 in accordance with an embodiment. User worldview database 360 comprises a user device identifier column 1511 holding an identifier of a user device. Database 360 also includes a learn column 1513, a inspire column 1515, a fun column 1517, and an ethics column 1519, holding values assigned by a user to the learn, inspire, fun, and ethics parameters, respectively. Database 360 also comprises a religion column 1521 indicating the user's answer (if any) concerning religion, a politics column 1523 indicating the user's answer (if any) concerning politics, an age column 1525 indicating any age limit the user specified for content, and a violence column 1527 specifying any restriction the user entered regarding violent content. Database 360 may also include additional columns indicating additional restrictions a user may specify concerning other topics. For example, in the illustrative embodiment, database 360 includes an evolution column 1529 indicating whether or not the user wishes to allow or block content relating to evolution.

Thus, records 1541, 1542, and 1543 contain criteria associated with user devices 160-A, 160-B, and 160-C, respectively. Referring in particular to record 1542, the user of user device 160-B indicated “7” for learn, “6” for inspire, “2” for fun, and “6” for ethics (columns 1513, 1515, 1517, 1519). The user did not provide information for either religion or politics (columns 1521, 1523). Referring to columns 1525 and 1527, the user specified that only content directed to children under age 16 is to be permitted, and that no violent content is allowed. Referring to column 1529, the user indicated that content related to evolution is permitted.

Referring now to record 1543, the user of user device 160-C indicated “5” for learn, “4” for inspire, “7” for fun, and “6” for ethics (columns 1513, 1515, 1517, 1519). The user did not provide information for religion (column 1521) but indicated a “conservative” political viewpoint (column 1523). Referring to columns 1525 and 1527, the user indicated that content for all ages is to be permitted, and that violent content is allowed. Referring to column 1529, the user indicated that content related to evolution is prohibited.

In accordance with an embodiment, content is filtered based on the combined ratings stored in combined content ratings database 450 and on user parameters associated with a particular user. FIG. 16 is a flowchart of a method of filtering content in accordance with an embodiment.

At step 1610, a plurality of ratings associated with content accessible at an internet address is received from a plurality of users, wherein each of the ratings corresponds to one of a plurality of content attributes. As described above, ratings for various items of content accessible via network 105 are received from various users and stored in user ratings database 448.

At step 1620, a combined set of ratings is generated for the content based on the plurality of ratings, the combined set of ratings comprising, for each of the plurality of content attributes, a combined rating value. For each item of content, a combined set of ratings is generated, as described above, and stored in combined content ratings database 450. Thus, referring to FIG. 11 and/or FIG. 13, a combined set of ratings is generated and stored for the history website (record 1146, for example) and for the Blood & Guts Videogame website (record 1147, for example). The combined ratings may be weighted averages based at least in part on user trust scores, as shown in FIG. 13.

At step 1630, a plurality of criteria are received from a user device, wherein each criterion corresponds to a respective one among the plurality of content attributes. As described above, a user, such as the user of user device 160-B, may enter a set of parameters defining his or her preferences, opinions, worldview, etc. Such parameters are stored in user worldview database 360 (shown in FIG. 3).

At step 1640, a request to access the content is received from the user device. Suppose now that a person employing user device 160-B (for example, a teenage son of the original user) attempts to access Blood & Guts videogame website. In the illustrative embodiment, the request to access the website is transmitted to content manager 140.

At step 1650, the combined set of ratings is compared to the plurality of criteria received from the user device. Filtering module 140 examines the request and identifies the source thereof as user device 160-B. Filtering module 140 therefore requests from user worldview service 120 the filtering parameters associated with user device 160-B. User worldview service 120 accesses user worldview database 360 and provides the filtering parameters associated with user device 160-B. Filtering module 140 stores the filtering parameters for user device 160-B in a user worldview file 570 in storage 530 (of content manager 140). Content manager 140 also requests from ratings service 130 the combined content ratings associated with the Blood & Guts Videogame website. In response, ratings service accesses combined content ratings database 450, retrieves the combined ratings associated with the Blood & Guts Videogame website, and provides the combined ratings to content manager 140. Filtering module 520 stores the combined ratings in a content ratings file 580 within storage 530. Filtering module 520 now compares the combined content ratings with the user filtering parameters.

Filtering module 520 examines the filtering parameters associated with user device 160-B (shown in record 1542 of FIG. 15) and the combined ratings associated with the Blood & Guts Videogame website (shown in record 1347 of FIG. 13, for example). Filtering module 520 determines that the Blood & Guts Videogame website has a weighted percentage violence rating of 99%, which conflicts with the user filtering criterion for violence (“NO”). Also, the combined ratings of the Blood & Guts Videogame website conflict with several of the filtering requirements of user device 160-B, including the requirement for the learn attribute (0.6 vs. 7) and the inspire attribute (1.5 vs. 6).

At step 1660, the user device is allowed to access the content if the combined set of ratings does not conflict with the plurality of criteria. At step 1670, the user device is prevented from accessing the content if the combined set of ratings conflicts with the plurality of criteria. Because the Blood & Guts Videogame website's combined ratings conflict with the user filtering criteria, user device 160-B is prevented from accessing the Blood & Guts Videogame website. Filtering module 520 may cause user device 160-B to display a message informing the user that he or she is not permitted to access the requested content. In the illustrative embodiment, user device 160-B displays a message 1725 stating “This Content Has Been Blocked,” as shown in FIG. 17.

In accordance with another embodiment, network manager 135 monitors online activity of a user (or user device) and compiles and displays usage and interaction information concerning the online activity. FIG. 18A is a flowchart of a method of monitoring and displaying online activity in accordance with an embodiment. At step 1810, online activity conducted via a user device is monitored. For example, in an illustrative embodiment, a first user (e.g., a parent) of user device 160-B wishing to monitor usage of the device by a second user (e.g., his or her child's usage) accesses a parental control page such as that shown in FIG. 18B. Parental control page 1800 includes a “Change Filtering Parameters” button 1805 and a “View Online Activity” button 1810. The parent, wishing to view statistics describing the child's online activities, selects “View Online Activity” button 1810.

In one embodiment, network manager 135 may consolidate all online activity conducted via user device 160-B in compiling usage information. In another embodiment, network manager 135 may monitor online activities conducted by one particular user among several users of user device 160-B. For example, in one embodiment, user device 160-B may require entry of a personal password before using the device. Based on the password, network manager 135 may determine which user is currently employing user device 160-B and track that particular user's online activities.

At step 1820, usage information is recorded by the user device based on access by the user device to a first website via a network. For example, network manager 135 may compute how many hours a particular user spends at various websites, and how many hours the individual spends doing various types of online activities. Network manager 135 stores such usage information in user behavior database 272.

At step 1830, interaction information relating to an interaction that occurs via a social networking website different from the first website is recorded by the user device, based on access by the user device to the social networking website via the network. Network manager 135 may monitor the user's activities when he or she accesses certain third party services that allow users to interact with other users, such as social networking websites, email servers, etc. For example, network manager 135 may examine a personalized social networking page(s) created by a particular user within a social network maintained by third party social network service 155, and determine how many messages the individual has sent and received during a specified period of time. Network manager 135 may also examine the user's personalized social networking page and determine how many new friends the individual has acquired within the social network. Similarly, when the individual accesses an email server, such as third party email server 158, network manager 135 may examine messages in the mailbox, messages received, messages sent, the content of messages, etc. Such interaction data may be stored in user behavior database 272 within storage 230 (of network manager 135).

In another embodiment, when an individual visits his or her personalized social network page associated with a social networking website (such as a website associated with third party social network service 155, for example), network manager 135 may obtain the individual's username and password, and, at a later time, automatically access the individual's personalized page based on the username and password to obtain desired interaction information. Similarly, network manager 135 may obtain the individual's username and password when the individual accesses an email server (such as third party email server 158), and subsequently use the username and password to access the individual's email account and obtain desired interaction information.

Advantageously, retrieval and storage of such usage and interaction information enables a first user (e.g., a parent) to monitor usage of a user device by a second user (e.g., a child). In other embodiments, systems and methods described herein may be used for other purposes. For example, systems and methods described herein may be used by an employer to monitor online activity of an employee.

At step 1840, a summary of the online activity is generated based on the usage information and the interaction information. At step 1850, the summary is displayed on a display of the user device. Network manager 135 accesses user behavior database 272 and obtains usage and interaction information related to user device 160-B and/or a selected user. Network manager 135 generates a summary of the online activity and causes user device 160-B to display an online activity page such as that shown in FIG. 19. Online activity page 1900 shows selected usage and interaction information for user device 160-B.

For example, online activity page 1900 indicates how many hours were spent on user device 160-B in learning activities (row 1911), inspire activities (row 1913), fun activities (row 1915), ethics activities (1917). In one embodiment, an activity (e.g., visiting a particular website) is deemed to be a learning activity if the activity has an average learn rating greater than a predetermined value. For example, visiting a website may deemed to be a learning activity if the website has an average learn rating greater than 5.0. Similar principles may govern with respect to inspire activities, fun activities, and ethics activities.

Online activity page 1900 also indicates, in rows 1922, 1924, 1926, 1928, how many messages were sent and received by the user of user device 160-B. Specifically, row 1924 shows the total number of messages sent and received. Rows 1926 and 1928 show the number of messages exchanged with certain individuals (in this instance, Charlie and Emily).

Row 1931 indicates how many new friends have been acquired by the user of user device 160-B. For example, network manager 135 may monitor the user's access to one or more social networking websites, examine the user's personalized social networking pages at such sites, and detect when the user acquires a new friend within any one of such social networks.

Row 1945 indicates how many hours were spent watching videos. Rows 1952, 1954, 1956, 1958 indicate how many hours were spent playing online games (or locally stored games). Specifically, row 1954 indicates the total time (in hours) spent playing games. Rows 1956, 1958 show the number of hours spent playing selected games.

Online activity page 1900 comprises three columns 1903, 1905, 1907. Column 1903 holds information relating to activities conducted during the current day. Column 1905 holds information relating to activities conducted during the current week. Column 1907 holds information relating to activities conducted during the current month.

Thus, referring again to row 1911, in the illustrative embodiment of FIG. 19, the user spent 1.2 hours in learning activities today, 12.4 hours in learning activities during the current week, and 45.2 hours in learning activities during the current month. Referring to row 1924, for example, 14 messages were sent or received by the user.

Certain rows of online activity page 1900 include a “MORE” button that enables a viewer to obtain additional, more detailed information about the corresponding topic. For example, row 1911 includes a MORE button 1961 enabling a viewer to obtain additional information concerning learning activities conducted via user device 160-B. Row 1913 includes a MORE button 1962 enabling a viewer to obtain additional information concerning inspire activities conducted via user device 160-B. Row 1915 includes a MORE button 1963 enabling a viewer to obtain additional information concerning fun activities conducted via user device 160-B. Row 1917 includes a MORE button 1964 enabling a viewer to obtain additional information concerning ethics activities conducted via user device 160-B.

Similarly, row 1922 includes a MORE button 1965 enabling a viewer to obtain more detailed information concerning messages that were sent and received by the user of user device 160-B. Row 1931 includes a MORE button 1966 enabling a viewer to obtain additional information concerning new friends acquired. Row 1945 includes a MORE button 1967 enabling a viewer to obtain additional information concerning videos watched by the user of user device 160-B. Row 1952 includes a MORE button 1968 enabling a viewer to obtain additional information concerning games played by the user of user device 160-B.

FIG. 19 is for illustrative purposes. In other embodiments, an online activity page may show other types of information not shown in FIG. 19.

In the illustrative embodiment, the (parent) user now wishes to view additional information concerning the child's learning activities, and accordingly selects MORE button 1961. Network manager 135 receives the selection and causes user device 160-B to display a Learn Activities page such as that shown in FIG. 20. Learn activities page 2000 includes a date field 2005 indicating that information is displayed for the current date “MM/DD/YYYY.” Page 2000 also includes a list of websites 2011, 2012, 2013 which are deemed to constitute learning activities and which were visited during the current day, and information indicating how many hours was spent visiting each respective website. Referring to field 2011, for example, 0.8 hours were spent visiting Website#1A. A link to each respective website is provided to enable the parent to visit and view any of the websites, if he or she wishes to know more about the child's online activities.

Learn activities page 2000 also includes a WEEK button 2022 and a MONTH button 2024. If the parent wishes to view details concerning learn activities for the current week, WEEK button 2022 may be selected. If the parent wishes to view details concerning learn activities for the current month, MONTH button 2024 may be selected.

Supposing the parent returns to online activity page 1900 and now wishes to view additional information concerning the child's inspire activities, the parent accordingly selects MORE button 1962. Network manager 135 receives the selection and causes user device 160-B to display an Inspire Activities page such as that shown in FIG. 21. Inspire activities page 2100 includes a date field 2101 indicating that information is displayed for the current date “MM/DD/YYYY.” Page 2100 also includes a list of websites 2102, 2103 which are deemed to constitute inspire activities and which were visited during the current day, and information indicating how many hours was spent visiting each respective website. Referring to field 2102, for example, 0.3 hours were spent visiting Website#1B. A link to each respective website is provided to enable the parent to visit and view any of the websites, if he or she wishes to know more about the child's online activities.

Inspire activities page 2100 also includes a WEEK button 2122 and a MONTH button 2124. If the parent wishes to view details concerning inspire activities for the current week, WEEK button 2122 may be selected. If the parent wishes to view details concerning inspire activities for the current month, MONTH button 2124 may be selected.

Supposing the parent returns to online activity page 1900 and now wishes to view additional information concerning the child's fun activities, the parent accordingly selects MORE button 1963. Network manager 135 receives the selection and causes user device 160-B to display a Fun Activities page such as that shown in FIG. 22. Fun activities page 2200 includes a date field 2201 indicating that information is displayed for the current date “MM/DD/YYYY.” Page 2200 also includes a list of websites 2202, 2203, 2204 which were visited during the current day, and information indicating how many hours was spent visiting each respective website. Referring to field 2202, for example, 1.8 hours were spent visiting Website#1C. A link to each respective website is provided to enable the parent to visit and view any of the websites, if he or she wishes to know more about the child's online activities.

Fun activities page 2200 also includes a WEEK button 2222 and a MONTH button 2224. If the parent wishes to view details concerning fun activities for the current week, WEEK button 2222 may be selected. If the parent wishes to view details concerning fun activities for the current month, MONTH button 2224 may be selected.

Supposing the parent returns to online activity page 1900 and now wishes to view additional information concerning the child's ethics activities, the parent accordingly selects MORE button 1964. Network manager 135 receives the selection and causes user device 160-B to display an Ethics Activities page such as that shown in FIG. 23. Ethics activities page 2300 includes a date field 2301 indicating that information is displayed for the current date “MM/DD/YYYY.” Page 2300 also includes a list of websites 2302, 2303 which were visited during the current day, and information indicating how many hours was spent visiting each respective website. Referring to field 2302, for example, 0.2 hours were spent visiting Website#1D. A link to each respective website is provided to enable the parent to visit and view any of the websites, if he or she wishes to know more about the child's online activities.

Ethics activities page 2300 also includes a WEEK button 2322 and a MONTH button 2324. If the parent wishes to view details concerning ethics activities for the current week, WEEK button 2322 may be selected. If the parent wishes to view details concerning ethics activities for the current month, MONTH button 2324 may be selected.

Suppose now that the parent wishes to view additional information concerning the child's messaging activities; the parent accordingly returns to online activity page 1900 and selects MORE button 1965. Network manager 135 receives the selection and causes user device 160-B to display a messages page such as that shown in FIG. 24. Messages page 2400 shows information relating to messaging activities conducted during the current day. Messages page 2400 comprises a Total Number of Messages field 2401 indicating the total number of messages sent and received by the (child) user. Fields 2403 and 2405 provide further detail indicating respectively the number of messages sent and the number of messages received.

Messages page 2400 also shows messaging activity broken into categories. Specifically, field 2412 shows the numbers of texts sent and received, fields 2414 and 2416 show the number of texts exchanged between the (child) user and two friends (Charlie, Emily, respectively). Field 2421 shows the numbers of chat messages sent and received, fields 2423 and 2425 show the number of chat messages exchanged between the (child) user and the two friends (Charlie, Emily). Field 2432 shows the numbers of email messages sent and received, fields 2434 and 2436 show the number of email messages exchanged between the (child) user and the two friends (Charlie, Emily, respectively).

Messages page 2400 also comprises a WEEK button 2452 and a MONTH button 2454. If the parent wishes to view details concerning messaging activities for the current week, WEEK button 2452 may be selected. If the parent wishes to view details concerning messaging activities for the current month, MONTH button 2454 may be selected.

Messages page 2400 also comprises a View Texts button 2441 that enables the parent to access text messages the (child) user exchanged with others, a View Chat Messages button 2442 that enables the parent to access chat messages the (child) user exchanged with others, and a View Emails button 2443 that enables the parent to access email messages the (child) user exchanged with others.

Supposing that the parent wishes to examine the chat messages that the (child) user exchanged with his or her friends, the parent may select View Chat Messages button 2442, response to the selection, network manager 135 causes user device 160-B to display a Chat Messages page such as that shown in FIG. 25. Chat messages page 2500 shows a plurality of chat messages 2513, 2515, 2517, etc., exchanged between the (child) user and various friends. The content of each of the messages is displayed.

If the parent wishes to view information concerning new friends that the (child) user has acquired via one or more social networking websites, the parent may return to online activity page 1900 and select MORE button 1966. In response, network manager 135 causes user device 160-B to display a New Friends page such as that shown in FIG. 26. New Friends page 2600 includes a date field 2602 indicating that information relating to the current day is displayed. Field 2612 indicates the number of new friends acquired during the current day (4). Field 2621 specifies a first social networking website frequented by the (child) user, and fields 2622, 2623, 2624 display the names of new friends acquired at the first specified social networking website. A link to each respective new friend's social networking page is provided. Field 2632 specifies a second social networking website frequented by the (child) user, and field 2634 displays the name of a new friend acquired at the second specified social networking website. A link to the new friend's social networking page is provided.

New Friends page 2600 also comprises a WEEK button 2652 and a MONTH button 2654. If the parent wishes to view details concerning new friends acquired during the current week, WEEK button 2652 may be selected. If the parent wishes to view details concerning new friends acquired during the current month, MONTH button 2654 may be selected.

If the parent wishes to examine the videos that the (child) user watched, the parent may return to online activity page 1900 and select MORE button 1967. In response, network manager 135 causes user device 160-B to display a videos page such as that shown in FIG. 27. Videos page 2700 includes a date field 2702 indicating that information concerning videos watched during the current day is displayed. Field 2704 indicates the number of videos watched during the current day. Fields 2711, 2713, 2715 provide the names of videos watched and the amount of time spent watching each respective video.

Videos page 2700 also comprises a WEEK button 2752 and a MONTH button 2754. If the parent wishes to view details concerning videos watched during the current week, WEEK button 2752 may be selected. If the parent wishes to view details concerning videos watched during the current month. MONTH button 2754 may be selected.

If the parent wishes to examine the games that the (child) user played, the parent may return to online activity page 1900 and select MORE button 1968. In response, network manager 135 causes user device 160-B to display a games page such as that shown in FIG. 28A. Games page 2800 includes a date field 2802 indicating that information concerning games played during the current day is displayed. Field 2804 indicates the number of games played during the current day. Fields 2811, 2813, 2815 provide the names of one or more games played and the amount of time spent playing each respective game.

Games page 2800 also comprises a WEEK button 2852 and a MONTH button 2854. If the parent wishes to view details concerning games played during the current week, WEEK button 2852 may be selected. If the parent wishes to view details concerning games played during the current month, MONTH button 2854 may be selected.

In another embodiment, a user may earn points for various activities. Network manager 135 may monitor a user's activities and grant points for an activity that meets predetermined criteria. In various embodiments, points may be granted for any type of activity that an administrator wishes to encourage and/or reward, or for another reason. For example, a user may be granted points for completing a learning activity, or for winning a game, etc.

In another embodiment, a first user (e.g., a parent) may monitor one or more activities of a second user (e.g., a child). For example, a user (e.g., the parent) may access a statistics page such as that shown in FIG. 28B. Statistics page 2840 comprises various regions showing statistics concerning various activities conducted by the second user. For example, a first webview 2858 includes a plurality of regions related to various activities. Region 2841 indicates how many points the second user has acquired during the current day, during the current week, and during the current month; region 2842 indicates how many hours the second user has spent in learning activities during the current day, during the current week, and during the current month; region 2843 indicates the total time the second user has spent online during the current day, during the current week, and during the current month; region 2844 indicates how many messages the second user has received/sent during the current day, during the current week, and during the current month, and provides similar information for different types of messages (e.g., email, chat, etc.); region 2845 indicates how many to-dos are completed/pending/incomplete during the current day, during the current week, and during the current month; region 2846 indicates how many new friends the second user acquired during the current day, during the current week, and during the current month; region 2847 indicates how many websites the second user visited during the current day, during the current week, and during the current month; region 2848 indicates how many games were visited/accessed, and how much time the second user spent on games, during the current day, during the current week, and during the current month; region 2849 indicates how many videos were watched, and how much time the second user spent watching videos during the current day, during the current week, and during the current month.

A second webview 2856 comprises a list of tabs corresponding to the regions shown in webview 2854. If the user wishes to obtain additional information concerning information shown in one of the regions of webview 2854, the user may select a corresponding tab in webview 2852. For example, if the first user wishes to obtain further information concerning the number of points obtained by the second user, the first user may select a tab 2856 labelled “Points.”

In response to the first user's selection, a points page such as that shown in FIG. 28C is displayed. Page 2830 comprises a field 2825 indicating a current number of points, a field 2827 indicating a number of points acquired during the current week, and a field 2829 indicating a number of points acquired during the current month. Page 2830 also includes fields 2834, 2836, 2838 indicating how many points were acquired during various specified weeks. A user may select an option and obtain a field 2839 indicating further detail concerning how points were acquired during a specified day.

In another embodiment, user device 160 transmits to network manager 135 a copy of an extracted (or “scraped”) page content in combination with meta data such as how long the page took to load, did the user bounce (immediately leave the page) did they stay on for a reasonable amount of time that would show that they read or otherwise consumed the content of the page, along with other metrics that could be valuable in showing how members interact with the content and the likely opinions they have of the content. Network manager 135 stores such information.

In another embodiment, a user is able to click the name and/or logo of another company and the keyword that the user previously entered can be automatically searched via the search engine the user wanted to use, without the user having to re-type the keywords. A list of search engines is shown in a first webview, while the search engine results are shown in a second webview. FIG. 28D shows a page 2860 comprising a first webview 2862 and a second webview 2864. First webview 2862 includes list 2868 of search engines accessible via the Internet. Webview 2864 includes a first region 2871 showing various search results from the world wide web, a second region 2873 showing search results that comprise photographs, and a third region 2875 showing search results that comprise videos. Information 2885 comprising content extracted, statistics/reports, page load times, data indicating whether the user bounced, and time spent on a web page, may be transmitted to network manager 135.

In another embodiment illustrated in FIG. 28E, a system and method are provided that allow a parent to control how and when parental settings apply to a child profile. A child profile is associated with a parent profile, and settings and parameters specified in the parent profile apply to the child's profile. The parent may also specify one or more time periods during which the settings/parameters apply to the child profile (during other times the settings do not apply). Referring to FIG. 28E, a child profile 3012 is associated with a parent profile 3010. For example, the parent profile may comprise the child profile. A parental settings box 3020 is shown; a parental settings box may be displayed on a user device 160, for example. Parental settings box 3020 comprises time fields 3021, 3022 and day fields 3025 that enable the parent to specify a time period and one or more days during which parental settings apply to the child profile.

In another embodiment illustrated in FIG. 28F, a system and method for enabling a parent to report offensive or unacceptable content is provided. Reporting box 3100 may be displayed on a user device 160, for example. Reporting box 3100 comprises an identifier field 3111 identifying the parent (e.g., by name), a and several category and characterization fields including fields 3112, 3113, 3114 that allow a parent to specify an offensive attribute of the content (e.g., violence, vulgarity, etc.) and specify a degree of such attribute (e.g., high, moderate, low).

In another embodiment illustrated in FIG. 28G, a system and method for filtering a friend request directed to a child (or child profile) via a social network (or other similar network) are provided. A parent may specify in a parental settings portion of a parent profile whether or not to screen friend requests received by a child. For example, in FIG. 28F, a parental setting 3220 specifies that the parent wishes to screen all friend requests. If the setting specifies that friend requests are to be screened, when a friend request is received, the parent profile is examined. The parent profile (3230) may comprise additional parameters determining whether or not to accept a particular friend request. For example, the parent profile 3230 may require manual approval by the parent of each friend request directed at the child. Thus, in the illustrative example, a friend request 3210 is received. Because parental settings 3220 specify that friend requests are to be screened, parent profile 3230 is accessed and examined. If the friend request is acceptable, or approved, in accordance with parent profile 3230, the friend request is transmitted to the child profile 3240.

In another embodiment illustrated in FIG. 28H, a system and method are provided for enabling interaction between a parent profile 3310 and a parental settings file 3320. In the illustrative embodiment, parent profile 3310 comprises a first child profile 3311 and a second child profile 3312. Parental settings file 3320 comprises a portal settings file 3321 and a device settings file 3322. Portal settings file 3321 and device settings file 3322 may each apply to one or both child profiles 3311 and 3312.

In another embodiment illustrated in FIG. 28I, a system and method for tracking the location of a child are provided. A parent profile 3410 (stored in user device 160, for example) comprises a parental settings file 3411 and a child profile 3412. Parental settings file 3411 contains parameters specifying a geographical region within which the child is permitted, and outside of which the child is not allowed to go. Location data associated with a device carried by the child (for example, a cell phone), is received and compared to the location data stored in parent profile 3410. For example, the device carried by the child may have GPS capability to determine its location based on GPS signals received from GPS satellite 3430. The device may transmit location data which is received by user device 160. Parental settings file 3411 may specify that if the location data indicates that the child is outside the permitted region, the parent is notified.

In another embodiment illustrated in FIG. 28J, a system and method for managing a wish list is provided. A user may specify one or more items that he or she would like. The items may be any items available for sale at a popular online store, for example. Such a list is referred to as a “wish list.” The user's friends may access the user's wish list without the user's knowledge. While a friend views the user's wish list, an option is provided to the friend to access one or more online stores and purchase an item on the wish list. Referring to FIG. 28J, a wish list 3510 is created by a user. A friend 3530 accesses the wish list. While accessing the wish list, the friend may see a display of a list 3520 of online stores, including stores 3521, 3522, 3523, etc.

In various embodiments, the method steps described herein, including the method steps described in FIGS. 16 and/or 18A, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 16 and/or 18A, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 29. Computer 2900 includes a processor 2901 operatively coupled to a data storage device 2902 and a memory 2903. Processor 2901 controls the overall operation of computer 2900 by executing computer program instructions that define such operations. The computer program instructions may be stored in data storage device 2902, or other computer readable medium, and loaded into memory 2903 when execution of the computer program instructions is desired. Thus, the method steps of FIGS. 16 and/or 18A can be defined by the computer program instructions stored in memory 2903 and/or data storage device 2902 and controlled by the processor 2901 executing the computer program instructions. For example, the computer program instructions can be implemented as computer executable code programmed by one skilled in the art to perform an algorithm defined by the method steps of FIGS. 16 and/or 18A. Accordingly, by executing the computer program instructions, the processor 2901 executes an algorithm defined by the method steps of FIGS. 16 and/or 18A. Computer 2900 also includes one or more network interfaces 2904 for communicating with other devices via a network. Computer 2900 also includes one or more input/output devices 2905 that enable user interaction with computer 2900 (e.g., display, keyboard, mouse, speakers, buttons, etc.).

Processor 2901 may include both general and special purpose microprocessors, and may be the sole processor or one of multiple processors of computer 2900. Processor 2901 may include one or more central processing units (CPUs), for example. Processor 2901, data storage device 2902, and/or memory 2903 may include, be supplemented by, or incorporated in, one or more application-specific integrated circuits (ASICs) and/or one or more field programmable gate arrays (FPGAs).

Data storage device 2902 and memory 2903 each include a tangible non-transitory computer readable storage medium. Data storage device 2902, and memory 2903, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 2905 may include peripherals, such as a printer, scanner, display screen, etc. For example, input/output devices 2905 may include a display device such as a cathode ray tube (CRT) or liquid crystal display (LCD) monitor for displaying information to the user, a keyboard, and a pointing device such as a mouse or a trackball by which the user can provide input to computer 2900.

Any or all of the systems and apparatus discussed herein, including network manager 135, user worldview service 120, ratings service 130, content manager 140, and components thereof, including, for example, controller 210, user registration & login module 220, storage 230, etc., may be implemented using a computer such as computer 2900.

One skilled in the art will recognize that an implementation of an actual computer or computer system may have other structures and may contain other components as well, and that FIG. 29 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of providing information, the method comprising:
monitoring, by a user device, online activity conducted via the user device;
recording, by the user device, usage information based on access by the user device to a first website via a network;
recording, by the user device, based on access by the user device to a social networking website via the network, interaction information relating to an interaction that occurs via the social networking website, the social networking website being different from the first website;
generating a summary of the online activity based on the usage information and the interaction information; and
displaying the summary on a display of the user device.

2. The method of claim 1, wherein the usage information indicates an amount of time spent by a user accessing the first website.

3. The method of claim 1, wherein the interaction comprises one of receipt of a message, transmission of a message, and acquisition of a new friend.

4. The method of claim 3, further comprising:
accessing, via a personalized social networking page associated with a user, information relating to one or more messages sent or received by the user via the social networking website.

5. The method of claim 3, further comprising:
accessing, via a personalized social networking page associated with a user, information relating to one or more friends acquired by the user via the social networking website.

6. The method of claim 1, further comprising:
obtaining, by the user device, access information for accessing the social networking website while a user accesses the social networking website; and
accessing the social networking website automatically, by the user device, based on the access information.

7. The method of claim 6, wherein the access information comprises one of a username and a password.

8. A system comprising:
a storage adapted to store information;
a display; and
a processor adapted to:
monitor online activity conducted via the system;
record, in the storage, usage information based on access by the system to a first website, via a network;
record, in the storage, based on access by the system to a social networking website, via the network, interaction information relating to an interaction that occurs via the social networking website, the social networking website being different from the first website;
generate a summary of the online activity based on the usage information and the interaction information; and
display the summary on the display.

9. The system of claim 8, wherein the usage information indicates an amount of time spent by a user accessing the first website.

10. The system of claim 8, wherein the interaction comprises one of receipt of a message, transmission of a message, and acquisition of a new friend.

11. The system of claim 10, wherein the processor is further adapted to:
access, via a personalized social networking page associated with a user, information relating to one or more messages sent or received by the user via the social networking website.

12. The system of claim 10, wherein the processor is further adapted to:
access, via a personalized social networking page associated with a user, information relating to one or more friends acquired by the user via the social networking website.

13. The system of claim 8, wherein the processor is further adapted to:
obtain access information for accessing the social networking website while a user access the social networking website; and
access the social networking website automatically based on the access information.

14. The system of claim 13, wherein the access information comprises one of a username and a password.
